(19) United States
(12) Patent Application Publication
(10) Pub. No.: US 2004/0204996 A1
(43) Pub. Date: Oct. 14, 2004

(54) Advertising and fundraising system and method

(76) Inventors: James D. Miralles, Omaha, NE (US); Rebecca S. Miralles, Omaha, NE (US); Shelly Osentowski, Omaha, NE (US)

Correspondence Address: LAW OFFICES OF ADAM H. JACOBS, PATENT ATTORNEY, SUITE 726, 1904 FARNAM STREET, OMAHA, NE, 68102, US

(21) Appl. No.: 10/820,419

(22) Filed: Apr. 8, 2004

Related U.S. Application Data
(60) Provisional application No. 60/461,096, filed on Apr. 8, 2003.

(51) Int. Cl. G06F 17/60

(52) U.S. Cl. 705/14

(57) ABSTRACT

The present invention provides a system and method for fundraising and marketing including the steps of contacting at least one merchant/vendor to obtain merchandise and service discounts and offers and receiving advertising content relating thereto. The advertising content is converted and organized into electronic format advertising, and the electronic format advertising is then transferred and stored on portable electronic format advertising storage media such as a credit card CD-ROM. The portable electronic format advertising storage media is then provided to fundraisers and the fundraisers then distribute it to purchasers whereby funds are raised. The purchasers then view the electronic format advertising on the portable electronic format advertising storage media via a computer system to obtain information on the merchandise and service discounts and offers. Finally, the merchandise and service discounts and offers are redeemed by the purchasers via display of the portable electronic format advertising storage media to the merchant/vendors.

### CROSS-REFERENCE TO RELATED PROVISIONAL APPLICATION

This application claims priority to the filing date of related provisional patent application serial No. 60/461,096 filed on Apr. 8, 2003.

### BACKGROUND OF THE INVENTION

1. Technical Field

The present invention relates to advertising and fundraising methods and, more particularly, to an advertising and fundraising system and method in which a plurality of separate business entities provide marketing materials which are combined onto a single piece of electronic media, the marketing materials including coupons and discounts applicable to the separate business entities, the packaged electronic media being distributed through various marketing channels to consumers who then may access the advertising information contained on the electronic media to patronize the business entity while displaying the electronic media as indicia for redeeming the coupon or discount.

2. Description of the Prior Art

With the proliferation of not-for-profit organizations such as charities, hospitals and schools, there has been an equal growth in the amount of fundraising which must be done to permit these organizations to continue functioning. Fundraising doesn't stop with not-for-profit organizations, however, as numerous organizations and foundations all need to raise funds to continue their operations. There are, of course, thousands of different types of fundraising vehicles which can be used by these organizations, and particular fundraising vehicles may be particularly suited for use with certain organizations. However, one type of fundraising vehicle which has been found to be particularly successful is the coupon book which has been in use for many years.

In general, the coupon book fundraising program would involve contacting a group of merchants who each agree to supply a discounted service or discounted good in exchange for being entered in the advertising coupon book. The coupon books are then distributed to purchasers at a set price which produces a profit margin for the fundraiser. The purchaser of the coupon book then may redeem the coupon for the discounted good or service with the merchant, thus completing the transaction. While this type of fundraising system is fairly good at connecting the merchants with the customers, it is also limited in that the advertising which the merchant may provide to the purchaser is restricted to print advertising only and therefore the advertising message from the merchant is limited in appeal. Furthermore, due to the inconvenient size and weight of the coupon book, it is often difficult for the purchaser of the coupon book to gain full use of the coupon book as they must carry the coupon book with them where ever they visit in order to use the coupon books with the various merchants. There is therefore a need for an easy to use and convenient fundraising system which is easily redeemable by the merchants yet is easily carried by the purchasers.

An attempt to solve this problem has been made by several companies in that they supply a credit card-like card for the purchaser to carry with them, the card operating such that when it is shown at the merchant, the merchant will redeem the coupon which has been purchased by the purchaser. Although this credit card-like card does alleviate some of the problems encountered with the fund raising systems of the prior art, it does not solve in any way the issue of the advertising which the merchant is able to use in connection with the fund raising program. There is still therefore a need for an easily used fundraising system which permits the merchant to advertise their goods or services in the most appealing and effective manner possible.

Therefore, an object of the present invention is to provide an improved advertising and fundraising system and method.

Another object of the present invention is to provide an advertising and fundraising system and method which incorporates advertising electronic media such as a credit card CD-ROM which may be accessed by the purchaser and will include enhanced visuals and graphics to provide high-quality advertising for the merchants connected with the card.

Another object of the present invention is to provide an advertising and fundraising system and method in which a plurality of merchants may be advertised simultaneously on the credit card CD-ROM in order to provide effective and efficient advertising for the merchants connected with the fundraising method.

Another object of the, present invention is to provide an advertising and fundraising system and method in which distribution of coupon books is eliminated, thus greatly increasing the efficiency of the fundraising system.

Finally, an object of the present invention is to provide an advertising and fundraising system and method which is relatively inexpensive to introduce and safe, efficient and effective in use.

### SUMMARY OF THE INVENTION

The present invention provides a system and method for fundraising and marketing including the steps of contacting at least one merchant/vendor to obtain merchandise and service discounts and offers and receiving advertising content containing the merchandise and service discounts and offers from the merchant/vendor. The advertising content received from the merchant/vendor is then converted and organized into electronic format advertising, and the electronic format advertising is then transferred and stored on portable electronic format advertising storage media such as a credit card CD-ROM. The portable electronic format advertising storage media is then provided to fundraisers and the fundraisers then distribute the portable electronic format advertising storage media to purchasers whereby funds are raised. The purchasers then may view the electronic format advertising on the portable electronic format advertising storage media via a computer system to obtain information on the merchandise and service discounts and offers. Finally, the merchandise and service discounts and offers are redeemed by the purchasers with the merchant/vendors via display of the portable electronic format advertising storage media to the merchant/vendors by the purchasers whereby the purchasers receive at least one of the merchandise and service discounts and offers.

It is thus seen that the present invention provides a substantial improvement over those fundraising systems and methods found in the prior art. For example, merchants who advertise using the present invention may include far more information and interest-generating advertising copy with their advertisements than that permitted in connection with prior types of fundraising systems and methods. Also, because the credit card CD-ROM of the present invention is compact and easy to carry, the purchasers of the fundraising system of the present invention may easily use the card without requiring the carrying of large and inconvenient coupon books. Finally, because the credit card CD-ROM of the present invention is capable of holding large quantities of information, a far greater number of merchants may be incorporated into the fundraising system which will thus greatly increase the profit margin which is obtainable by use of the fundraising system of the present invention. The present invention thus provides a significant improvement over those fundraising systems and methods found in the prior art.

### BRIEF DESCRIPTION OF THE DRAWINGS

FIG. 1 is a high-level flow chart illustrating the method of the present invention; and

FIG. 2 is a more detailed flow diagram illustrating the method of the present invention.

### DESCRIPTION OF THE PREFERRED EMBODIMENT

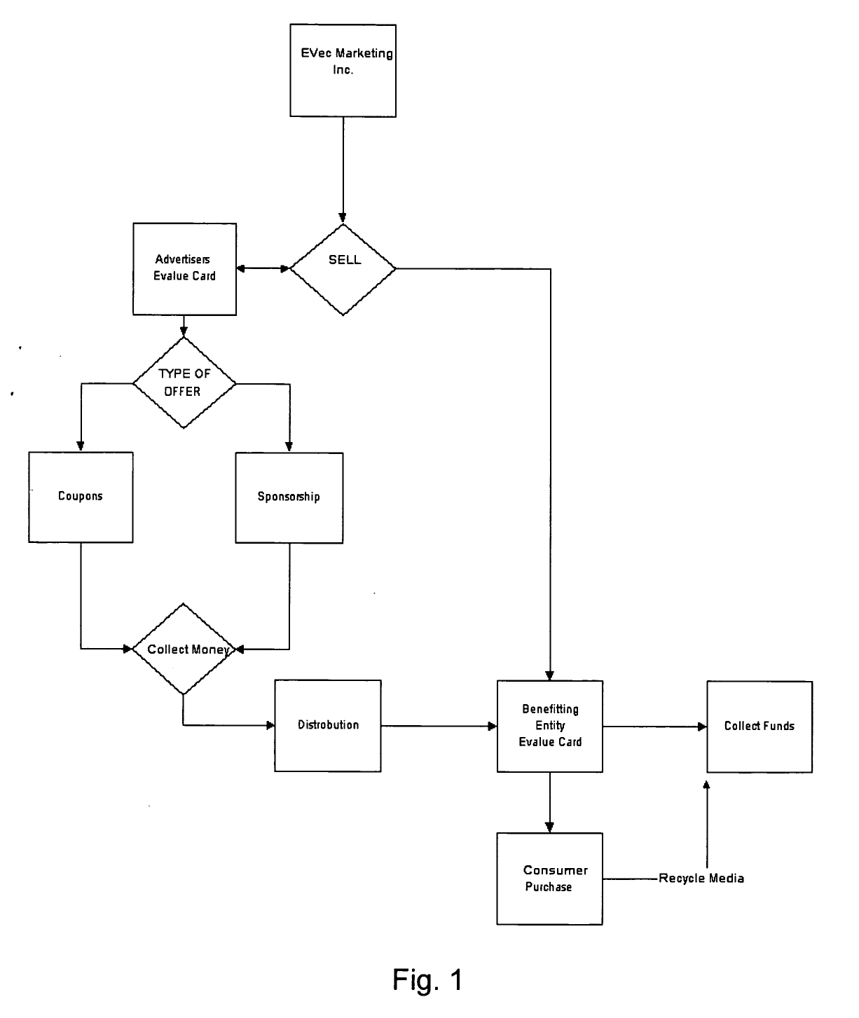

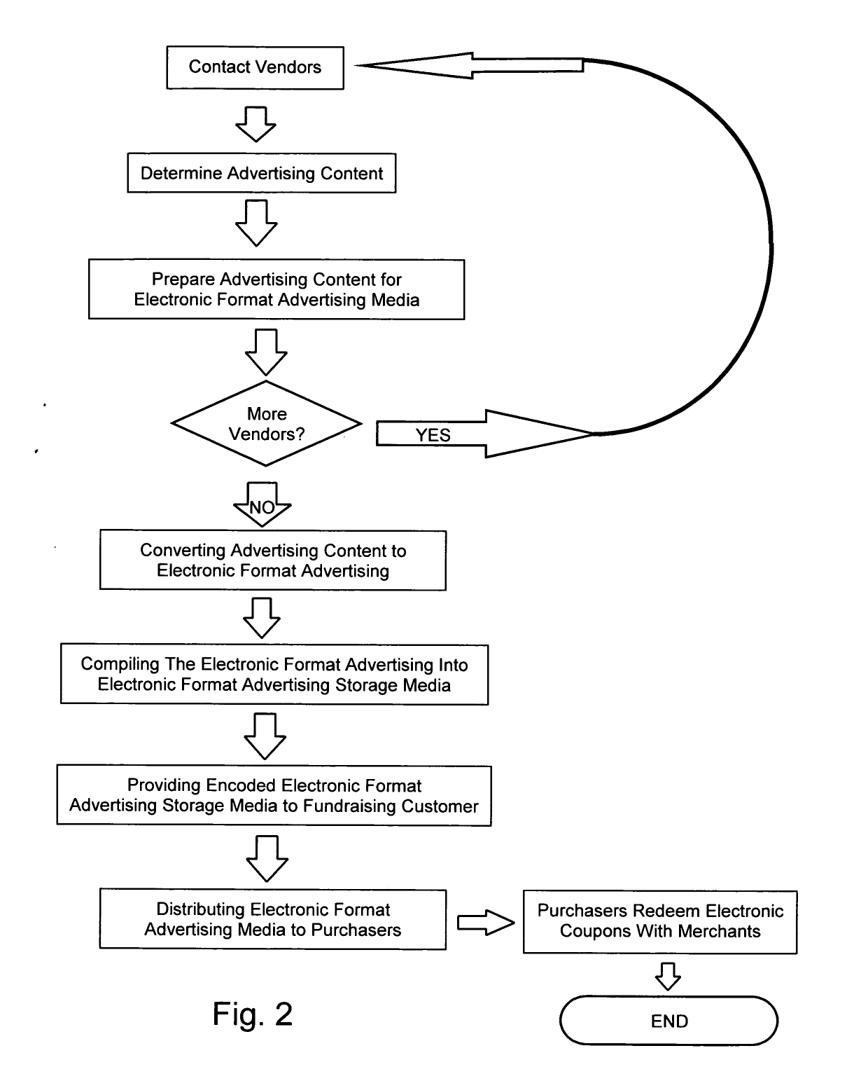

The advertising and fundraising system and method of the present invention is shown best in FIGS. 1 and 2 as including the following steps. Initially, a number of business entities would be contacted to be included on the advertising electronic media to be distributed. Each of the business entities or merchants would be entitled to include at least one ad in the electronic media, the ad to include a discount coupon or price reduction which can be redeemed by the purchaser of the electronic media. The discount or special offer may be of virtually any type, including but not limited to the following: buy one get one free, a weekly special, a percentage reduction off of the total bill, a free appetizer, or any other such discount or special offer. Also, the advertising may be of any appropriate type, including advertising copy, a reproduction of the menu, a graphic depiction of the business or business location, a map to facilitate finding of the business, and virtually any other commonly used print media advertising device to encourage redemption of the coupon or attendance at the business entity location.

Once each of the merchants has been lined up to advertise on the electronic media and have determined their various special offers and/or discount coupons to be included, all of the information is transferred to an electronic media for distribution thereof. In the preferred embodiment, the electronic media used would be a credit card-shaped CD-ROM which stores the advertising information from the merchants in an accessible electronic format thereon. The face of the credit card CD-ROM includes specific information pertaining to the campaign or fundraising event with which the credit card CD-ROM is associated. Other information such as the manufacturer of the credit card CD-ROM or the owner of the method rights may also be printed on the face of the credit card CD-ROM, depending upon the desires of the user of the invention.

Once all of the information regarding the merchants has been burned onto the credit card CD-ROM, the credit card CD-ROM is duplicated and prepared for distribution. In its intended use, the credit card CD-ROM serves as a fundraising vehicle for schools, non-profit organizations, corporations, or individual merchants who will charge consumers a certain price to purchase the credit card CD-ROM, thus permitting the consumer to access and use the various coupons and special discounts offered by the merchants on the credit card CD-ROM. Once the consumer has purchased the credit card CD-ROM, he or she may then insert the credit card CD-ROM into any available computer equipped with a CD-ROM reader and access the information contained thereon. The card would be placed in the CD drive of the computer and, in the preferred embodiment, the list of merchants would be presented in an automatic launch presentation. The directory of merchants would be made available to the consumer in order to permit the consumer to “page through” the various pages of advertising being presented until he or she has reached the desired ad to determine the discount being offered by the merchant. A significant improvement over the prior art is that the consumer may interact with the credit card CD-ROM to run searches or to view merchants page by page should the consumer desire to do so.

Finally, although it is an element of the present invention that the consumer may print out coupons from the credit card CD-ROM, it is preferred that the credit card CD-ROM itself be used to indicate to a merchant that purchase of the credit card CD-ROM has occurred, by displaying the credit card CD-ROM to the merchant, thus permitting the consumer to use the discount and/or special offer offered by the merchant without requiring printing of a coupon or the like. This is a key element of this invention in that the prior art methods invariably require accessing a particular page on the CD-ROM and obtaining access to a printer to print the coupon associated with the merchant. One must then make sure to bring the coupon to the merchant location in order to redeem the coupon, which means that the consumer must preplan his or her outing to go to the particular merchant for which the coupon is being printed. While there are many people who enjoy planning which restaurant they will attend, or specifying in advance which merchant location they will be visiting, there are just as many consumers who leave their households with a general plan of shopping and dining, without having specific destinations in mind. For these consumers, the accessing of information on a CD-ROM, the printing of particular coupons and the taking of those coupons with them does not serve their needs. Instead, it is only the present invention which satisfies those needs in a novel and unique way.

Specifically, the consumer would merely present the credit card CD-ROM to the merchant at the merchants location to obtain the discount or special offer which has been offered by the merchant on the credit card CD-ROM. Therefore, the credit card CD-ROM serves as indicia of the purchase of the discount coupons, and thus the merchant will redeem the proffered credit card CD-ROM for the particular discount or special offer being offered by the merchant. The ease and simplicity by which the present invention permits redemption of discounts and special offers is unprecedented and therefore is believed to be deserving of protection.

Numerous benefits of the present invention are conferred on both consumers and merchants who utilize the present invention, not to mention the fundraising organization which connects the merchants to consumers. For example, the credit card CD-ROM of the present invention is very user friendly and permits the consumer to easily carry the indicia permitting redemption of discounts and/or special offers in his or her wallet, purse or pocket. For merchants, the advertising method is extremely cost-effective and encourages patronizing of the merchant's location which will likely lead to more and further sales. Also, the relatively small size and weight of the credit card CD-ROM makes handling and distribution of the credit card CD-ROMs much easier than that offered by those fundraising methods found in the prior art. For example, redeemable coupon books have been around for years and are still used for fundraising purposes to this day. However, schools and non-profit organizations which utilize the coupon books for fundraising voice universal complaints regarding the unwieldy nature of the coupon books, which take up great amounts of space during storage of the coupon books and, due to the relatively heavy weight of the coupon books, are somewhat difficult to distribute to consumers. The present invention provides a novel and simple solution to those problems presented in the prior art which have not been solved to date. Also, the small size of the credit card CD-ROM permits for easy recycling of the credit card CD-ROM once the end of the fundraising campaign is reached. This makes the present invention very environmentally friendly and encourages recycling, also an improvement over the prior art.

Another important feature of the present invention is that usage of the credit card CD-ROM can be electronically tracked by the fundraiser, the merchant/vendor and/or the maker of the CD-ROM to obtain information which can be used for future fundraising ventures, in addition to answering the fundraiser's question as to the effectiveness of the campaign. Some of the information which can be tracked includes page hits in the use of the credit card CD-ROM, the number and percentages of redemptions with vendors, the number and nature of redemption requests, emails sent and received and the number of referrals to other vendors and merchants, all of which can be used to focus the fundraising system for future fundraising events.

Finally, a very important feature of the present invention is that the fundraising entity can be properly branded. With many of the fundraising systems of the prior art, the fundraising entity is very limited in the manner in which they may inform purchasers of the coupon book or the like of their identity. In fact, many of the prior art systems only permit the fundraising entity to attach a sticker or small, brief description to the fundraising device. Compare this to the present invention in which the fundraising entity may fully inform the purchaser of the credit card CD-ROM of their beliefs and creeds thus further encouraging the purchaser to continue their support of the fundraising entity. The present invention thus provides numerous features which are not found in the prior art and which render the present invention superior in many respects to those systems found in the prior art.

It is to be noted that numerous additions, modifications, and substitutions may be made to the present invention which fall within the intended broad scope of the above description. For example, the merchants and/or business entities included on the credit card CD-ROM may be varied according to the intentions of the user of the present invention. Furthermore, the precise nature of the electronic media used for storage of the advertising materials is critical only in that the electronic media must be compact and easily handled and lend itself to being portable so that the consumer may easily show the electronic media to the merchant, thus providing indicia of purchase of the discount and/or special offer. Also, the precise method by which the information on the electronic media is displayed on the computer is not critical to the present invention so long as the consumer may access the information to obtain information on the merchants included on the electronic media and their various discounts and/or special offers being offered. Finally, the specific details on obtaining merchants for inclusion on the electronic media and sale and distribution to the consumer are not critical and would be understood by one skilled in the art of fundraising and/or marketing.

There has therefore been shown and described an advertising and fundraising system and method which accomplishes at least all of its intended objectives.

We claim:

1. A system and method for fundraising and marketing comprising the steps:
contacting at least one merchant/vendor to obtain at least one of merchandise and service discounts and offers;
receiving advertising content containing said at least one of merchandise and service discounts and offers from said at least one merchant/vendor;
converting and organizing said advertising content received from said merchant/vendor into electronic format advertising;
transferring and storing said electronic format advertising on portable electronic format advertising storage media;
providing said portable electronic format advertising storage media to fundraisers;
distributing said portable electronic format advertising storage media via said fundraisers to purchasers whereby funds are raised;
viewing said electronic format advertising on said portable electronic format advertising storage media via a computer system to obtain said at least one of merchandise and service discounts and offers; and
redeeming at least one of said at least one of merchandise and service discounts and offers with said merchant/vendors via display of said portable electronic format advertising storage media to said merchant/vendors by said purchasers whereby said purchasers receive at least one of said at least one of merchandise and service discounts and offers.

2. The method of claim 1 wherein said step of converting and organizing said advertising content received from said merchant/vendor into electronic format advertising comprises placing said advertising content in the form of individual viewable electronic pages.

3. The method of claim 1 wherein said step of transferring and storing said electronic format advertising on portable electronic format advertising storage media comprises using a credit card-shaped CD-ROM as said portable electronic format advertising storage media.

4. The method of claim 1 wherein said step of distributing said portable electronic format advertising storage media via said fundraisers to purchasers comprises exchanging said portable electronic format advertising storage media for money whereby said purchasers purchase said electronic format advertising storage media thereby raising funds for said fundraiser.

5. The method of claim 1 wherein said step of viewing said electronic format advertising on said portable electronic format advertising storage media via a computer system comprises inserting said portable electronic format advertising storage media into said computer system and running said portable electronic format advertising storage media to access said electronic format advertising thereby permitting said purchaser to view said electronic format advertising.

6. A system and method for fundraising and marketing comprising the steps:
contacting at least one merchant/vendor to obtain at least one of merchandise and service discounts and offers;
receiving advertising content containing said at least one of merchandise and service discounts and offers from said at least one merchant/vendor;
converting and organizing said advertising content received from said merchant/vendor into electronic format advertising;
transferring and storing said electronic format advertising on a credit card-shaped CD-ROM;
providing said credit card-shaped CD-ROM to fundraisers;
distributing said credit card-shaped CD-ROM via said fundraisers to purchasers whereby funds are raised;
viewing said electronic format advertising on said credit card-shaped CD-ROM via a computer system to obtain said at least one of merchandise and service discounts and offers; and
redeeming at least one of said at least one of merchandise and service discounts and offers with said merchant/vendors via display of said credit card-shaped CD-ROM to said merchant/vendors by said purchasers whereby said purchasers receive at least one of said at least one of merchandise and service discounts and offers.

7. The method of claim 6 wherein said step of converting and organizing said advertising content received from said merchant/vendor into electronic format advertising comprises placing said advertising content in the form of individual viewable electronic pages.

8. The method of claim 6 wherein said step of distributing said portable electronic format advertising storage media via said fundraisers to purchasers comprises exchanging said portable electronic format advertising storage media for money whereby said purchasers purchase said electronic format advertising storage media thereby raising funds for said fundraiser.

9. The method of claim 6 wherein said step of viewing said electronic format advertising on said portable electronic format advertising storage media via a computer system comprises inserting said portable electronic format advertising storage media into said computer system and running said portable electronic format advertising storage media to access said electronic format advertising thereby permitting said purchaser to view said electronic format advertising.

10. A system and method for fundraising and marketing comprising the steps:
contacting at least two merchants/vendors to obtain from each at least one of merchandise and service discounts and offers;
receiving advertising content containing said at least one of merchandise and service discounts and offers from said at least one merchant/vendor;
converting and organizing said advertising content received from said merchant/vendor into electronic format advertising;
transferring and storing said electronic format advertising on a CD-ROM;
imprinting each of said CD-ROMs on an outer surface thereof with indicia identifying said CD-ROMs as being distributed by at least one selected fundraising entity;
providing said CD-ROM to said at least one fundraising entity;
distributing said CD-ROM via selling of said CD-ROM via said at least one fundraising entity to purchasers whereby funds are raised;
viewing said electronic format advertising on said CD-ROM via a computer system to obtain said at least one of merchandise and service discounts and offers; and
redeeming at least one of said at least one of merchandise and service discounts and offers with said at least two merchant/vendors via display of said CD-ROM to said at least two merchant/vendors by said purchasers whereby said purchasers receive at least one of said at least one of merchandise and service discounts and offers.

11. The method of claim 10 further comprising the step of preparing and recording electronic format information containing information regarding said at least one fundraising entity on said CD-ROM whereby said purchasers receive information regarding said at least one fundraising entity for their review thereby encouraging said purchasers to continue their support of said at least one fundraising entity.
